(19) United States
(12) Patent Application Publication
(10) Pub. No.: US 2016/0371753 A1
(43) Pub. Date: Dec. 22, 2016

(54) METHOD, APPARATUS, AND SYSTEM FOR CONTROLLING PUBLICATION OF NETWORK MEDIA INFORMATION

(71) Applicant: Tencent Technology (Shenzhen) Company Limited, Shenzhen (CN)

(72) Inventors: Shenglong LING, Shenzhen (CN); Chaojian ZHOU, Shenzhen (CN); Yong HU, Shenzhen (CN); Jun GUO, Shenzhen (CN)

(21) Appl. No.: 15/254,657

(22) Filed: Sep. 1, 2016

Related U.S. Application Data
(63) Continuation of application No. PCT/CN2015/072892, filed on Feb. 12, 2015.

(30) Foreign Application Priority Data
Mar. 4, 2014 (CN) 201410076911.2

(51) Int. Cl. G06Q 30/02; G06F 17/30

(52) U.S. Cl. CPC G06Q 30/0277; G06F 17/3089; G06Q 30/0264; G06Q 30/0275

(57) ABSTRACT

A method, an apparatus, and a system for controlling publication of network media information are disclosed. The method includes: sending a competition request message to more than one publishing party, the competition request message including a request duration, and the request duration being less than or equal to a total duration of a target display position; receiving competition reply messages returned by the more than one publishing party; and determining, according to the competition reply messages, whether corresponding publishing parties participate in competition, competition durations of participating in the competition, and competition exchange parameters; selecting, according to the competitions duration and the competition exchange parameters from the publishing parties that participate in the competition, a group of publishing parties; and sending network media information of the selected publishing parties to the target display position for publishing.

### CROSS REFERENCE TO RELATED APPLICATION

This application is a continuation of International Application No. PCT/CN2015/072892, filed on Feb. 12, 2015, which claims priority to Chinese patent application No. 201410076911.2, filed on Mar. 4, 2014, both of which are incorporated herein by reference in their entirety.

FIELD OF THE TECHNOLOGY

The present disclosure relates to Internet data processing technologies, and in particular, to a method, an apparatus, and a system for controlling publication of network media information.

### BACKGROUND OF THE DISCLOSURE

Network media information is information that is published on the Internet using various display forms (for example, a web page or a client interface) and is in a digital form. Generally, network media information corresponds to a destination web page; and by clicking the network media information, a user can jump to the corresponding destination web page, and content of the destination web page is displayed to the user. How to effectively deliver and display network media information to specific audience and effectively manage the displayed information is a field on which the Internet technology industry currently focuses attention.

Display processing technologies of network media information develop rapidly in recent years, and have already been applied to many industry fields. For example, in the field, of display processing of an Internet advertisement, the Internet advertisement is network media information. A major technology among the display processing technologies of network media information is a technology for controlling publication of network media information.

In a system for controlling publication of network media, information, by submitting a specific quantity of electronic certificates to the publication control system by using an electronic payment system, a user can obtain a service, provided by the publication control system, of publishing corresponding network media information. The electronic certificate is an electronic exchange tool, that is, an electronic payment certificate, which is, for example, in the form of a digital currency or an electronic card. In addition, in the publication control system, quantities of deducted electronic certificates required for publishing network media information are different. A quantity of deducted electronic certificates required for publishing network media information is a parameter based on which exchange between an action of publishing the network media information and electronic certificates is performed (“exchange parameter” for short), and is generally, for example, a price for publishing the network media information,

### SUMMARY

In view of this, embodiments of the present invention provide a method, an apparatus, and a system for controlling publication of network media information, which can improve usage of a network resource corresponding to a target network media information display position,

A method for controlling publication of network media information includes:

sending a competition request message to more than one publishing party, the competition request message including a request duration, and the request duration being less than or equal to as total duration of a target display position:

receiving competition reply messages returned by the more than one publishing party; and determining, according to the competition reply messages, whether corresponding publishing parties participate in competition, competition durations of participating in the competition, and competition exchange parameters;

selecting, according to the competition durations and the competition exchange parameters from the publishing parties that participate in the competition, a group of publishing parties whose competition duration sum is less than or equal to the total duration of the target display position and whose competition exchange parameter sum is a maximum value; and sending network media information of the selected publishing parties to the target display position for publishing.

An apparatus for controlling publication of network media information includes:

a competition request module, configured to send a competition request message to more than one publishing party, the competition request message including a request duration, and the request duration being less than or equal to a total duration of a target display position;

a competition reply module, configured to receive competition reply messages returned by the more than one publishing party, and determine, according to the competition reply messages, whether corresponding publishing parties participate in competition, competition durations of participating in the competition, and competition exchange parameters;

a competition computation module, configured to select, according to the competition durations and the competition exchange parameters from the publishing parties that participate in the competition, a group of publishing parties whose competition duration sum is less than or equal to the total duration of the target display position and whose competition exchange parameter sum is a maximum value; and

a publishing module, configured to send network media information of the selected publishing parties to the target display position for publishing

A system for controlling publication of network media information includes a front end display apparatus, the foregoing apparatus for controlling publication of network media information, and a publishing party apparatus;

the front end apparatus being configured to: send a network media information display request to the publication control apparatus when a target display position is opened, receive network media information published by the publication control apparatus, and display the received network media information at the target display position; and

the publishing party apparatus being configured to: receive a competition request message from the publication control apparatus; perform computation according to competition computation logic set by the publishing party apparatus, to determine whether to participate in competition, a competition duration of participating in the competition, and a competition exchange parameter; and return, to the publication control apparatus, a competition reply message that carries information indicating whether to participate in the competition, the competition duration of participating in the competition, and the competition exchange parameter.

By using the method for controlling publication of network media information according to the embodiments of the present invention, a competition duration that can be selected by a publishing party is not necessarily as total duration of a target display position, and is as part or even a small part of the total duration, thereby greatly reducing a probability of giving, up competition by a single publishing party. The present disclosure further combines more than one publishing party that participates in the competition, and publishes a corresponding set of network media information at the target display position. In this way, a probability of displaying network media information at the target display position is greatly increased, and a vacancy rate of a network resource corresponding to the display position is reduced, that is, usage of the network resource is improved, so that the network resource can be fully utilized for the network media information. The network resources include, but are not limited to: resources such as computation, storage, and bandwidth of various computing devices and related devices on which network operation relies, which are, for example, central processing unit (CPU) consumption, memory consumption or bandwidth transmission consumption.

### BRIEF DESCRIPTION OF THE DRAWINGS

FIG. 1 is a schematic diagram of processing real-time competition computation of an exchange parameter of graphical network media information;

FIG. 2 is a schematic diagram of processing real-time competition computation of an exchange parameter of pre-roll network media information;

FIG. 3 shows a method for controlling publication of network media information according to an embodiment of the present invention;

FIG. 4 shows an apparatus for controlling publication of network media information according to an embodiment of the present invention;

FIG. 5 is a schematic composition diagram of a client device according to an embodiment of the present invention;

FIG. 6 is another schematic composition diagram of an apparatus for controlling publication of network media information according to an embodiment of the present invention; and

FIG. 7 is still another schematic composition diagram of an apparatus for controlling publication of network media information according to an embodiment of the present invention.

### DESCRIPTION OF EMBODIMENTS

The following describes the present disclosure in further detail with reference to the accompanying drawings and specific embodiments.

In a current system for controlling publication of network media information, there appears a technical solution in which network media information that undergoes competition is published at a target display position. The “undergoing competition” refers to that for a certain target display position, real-time competition computation is performed on exchange parameters of network media information provided by multiple publishing parties, and network media information with a maximum exchange parameter of network media information is selected and published at the target display position. For example, in the field of Internet advertisement application, real-time competition computation performed on advertisement exchange parameters provided by multiple publishing parties is also generally referred to as “real time bidding” (RTB).

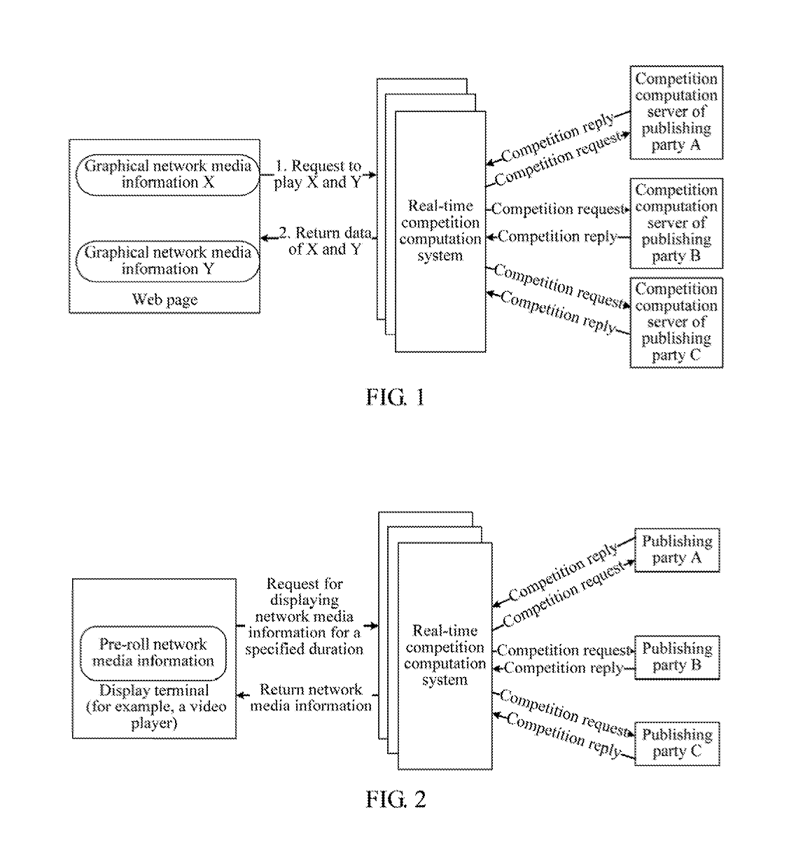

FIG. 1 is a schematic diagram of processing real-time competition computation of an exchange parameter of graphical network media information. Referring to FIG. 1, the processing specifically includes:

opening, by a user, a web page with a display code of network media information;

initiating, by a web page system to a real-time competition computation system 101 for an exchange parameter and by using a system for controlling publication of network media information, a request for playing network media information X and Y;

initiating, by the real-time competition computation system 101, a competition request to each publishing party competition computation server that has been connected to the current real-time competition computation system;

perform, by each publishing party competition computation server that receives the competition request, computation according to competition computation logic set by the publishing party competition computation server, to determine whether to participate in current competition for a opportunity of displaying the network media information; and returning a competition reply to the real-time competition computation system 101, where the competition reply includes information indicating whether to participate in the competition; and if yes, further needs to include a provided exchange parameter, for example, the provided exchange parameter may be a hid; and determining, by the real-time competition computation system 101 after receiving the competition reply, a winning publishing party according to real-time competition computation logic set by the real-time competition computation system 101; and returning data of network media information of the winning publishing party to the we page for display.

FIG. 2 is a schematic diagram of processing real-time competition computation of an exchange parameter of pre-roll network media information. Referring, to FIG. 2, the processing specifically includes:

opening, by a user, a video playback page or starting a video playback client, where the video playback page or the video playback client carries a display code of network media information;

initiating, by a video playback page system or a video playback client system to a real-time competition computation system 101 for an exchange parameter and by using a system for controlling publication of network media information, a request for playing network media information X and Y;

initiating, by the real-time competition computation system 101, a competition request to each publishing party competition computation server that has been connected to the current real-me competition computation system;

performing, by each publishing party competition computation server that receives the competition request, computation according to competition computation logic set by the publishing party competition computation server, to determine whether to participate in current competition for a opportunity of displaying the network media information; and returning a competition reply to the real-time competition computation system 101, where the competition reply includes information indicating whether to participate in the competition; and if yes, further needs to include a provided competition exchange parameter, for example, the provided competition exchange parameter may be a bid; and

determining, by the real-time competition computation system 101 after receiving the competition reply, a winning publishing party according to real-time competition computation logic set by the real-time competition computation system 101; and returning data of network media information of the winning publishing party to the video playback page or the video playback client for display.

As shown in FIG. 1 and FIG. 2, a target of the competition computation is a standardized network media information display position, for example, a banner with a fixed duration on as web page or entire pre-roll network media information with a fixed duration. A competition computation server of a publishing party that participates in the competition computation can only choose to process or choose not to process the network media information, and cannot choose to process a certain part of the network media information. As a result, when a duration or an exchange parameter of a target display position of network media information is beyond expectations of publishing parties, the publishing parties either choose to give up competition, or choose to compete with an excessively high cost, which is not flexible for the publishing parties. In addition, generally speaking, when a duration or an exchange parameter of a target network media information display position is beyond expectations of publishing parties, most publishing parties choose to give up competition. As a result, a vacancy rate of a network resource corresponding to the target network media information display position greatly increases, that is, usage of the network resource is rather low, and the network resource cannot be fully utilized. The network resources include, but are not limited to: resources such as computation, storage, and bandwidth of various computing devices and related devices on which network operation relies, which are, for example, CPU consumption, memory consumption, or bandwidth transmission consumption.

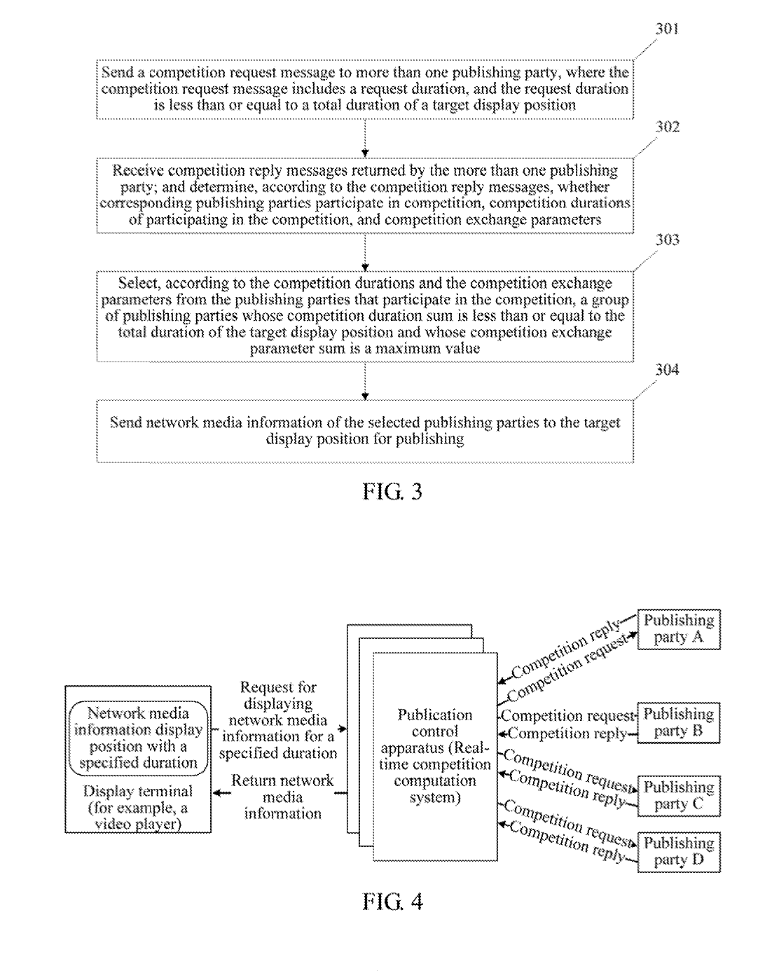

In view of this, FIG. 3 provides a method for controlling publication of network media information, and FIG. 4 provides an apparatus for controlling publication of network media information, where the publication control apparatus may also be a real-time competition computation system, and is configured to execute the method according to an embodiment of the present invention. The method includes;

Step 301: Send a competition request message to more than one publishing party, where the competition request message includes a request duration, and the request duration is less than or equal to a total duration of a target display position:

This step may be triggered in the following condition: when a user opens a display terminal having a network media information display position with a specified playback duration, the display terminal sends a network media information display request, where the network media information display request includes information such as an identifier of a target display position and a total duration of the target display position. In the present disclosure, after the network media information display request is received, a procedure of the present disclosure is triggered to perform real-time computation and publish corresponding network media information. Therefore, the publication control apparatus according to an embodiment of the present invention is also a real-time competition computation system.

Certainly, in another embodiment of the present invention, before the display terminal initiates the display request, the publication control apparatus may actively initiate execution of this method, that is, the publication control apparatus performs computation to obtain network media information that needs to be displayed at each target display position; and after the display terminal sends the display request, sends the network media information that needs to be displayed at the target display position to the display terminal for display.

The display terminal may be implemented by using a dedicated client, for example, a video playback client plays a video having a network media information display position; and may also be implemented by using a network browser, for example, a network browser is used to open a video web page having a network media information display position.

In the present disclosure, the network media information display position with a specified playback duration may have various forms, for example, may be a graphical display position with a specified display duration (for example, 30 seconds), such as a banner, and may also be a pre-roll display position with a specified display duration. Certainly, the network media information display position may also be of other network media information display forms such as flash, a text title, and scrolling information.

In this embodiment of the present invention, when a user opens a web page or starts a client, where the web page or the client carries a code of such a network media information display position, the publication control method of the present disclosure is triggered.

For example, in a preferred embodiment of the present invention, when a user starts a display terminal having a pre-roll network media information display position with a specified playback duration, the display terminal sends a network media information display request to the apparatus for controlling publication of network media information according to an embodiment of the present invention, where the request includes information about a target display position, and the information about the target display position may include an ID and a total duration of the target display position, or the information about the target display position may only include an ID of the display position, so that the publication control apparatus of the present disclosure queries a display position database according to the ID of the display position to obtain a corresponding total duration, where the total duration is a total duration of playing the pre-roil network media information. After receiving the network media information display request from the network media information display terminal, the publication control apparatus of the present disclosure triggers sending of the competition request message to more than one publishing party.

In a preferred embodiment of the present invention, before the competition request message is sent, the method may further include: determining a publishing party to which the competition request message is sent and a request duration corresponding to the publishing party, where the request duration is less than or equal to the total duration of the target display position.

That is, publishing parties of different types may be preset for different target display positions; and in the present disclosure, specific publishing parties to which the competition request message is sent need to be determined according to a target display position and preset information. In addition, each publishing party corresponds to one request duration, and request duration corresponding to different publishing parties may be the same or different. A specific determining manner may be pre-determined according to a reference parameter of a publishing party. For example, the reference parameter of the publishing party may be credit information; and in the present disclosure, a length of a request duration corresponding to the publishing party may be determined according to the credit of the publishing party. A higher credit indicates a longer length, but a request duration cannot exceed the total duration of the target display position,

In the present disclosure, the publishing party specifically refers to a publishing party competition computation server, and may also be referred to as a publishing party apparatus; and in this embodiment, a publishing party is short for the publishing party competition computation server.

After receiving the competition request message from the publication control apparatus, the publishing party competition computation server performs computation according to competition computation logic set by the competition computation server, to determine whether to participate in a current competition; if yes, determines a competition duration and a competition exchange parameter; and returns a competition reply message that carries the competition duration and the competition exchange parameter to the publication control apparatus.

The competition duration refers to a duration for which network media information of a current publishing party is published at a target display position once this publishing party is selected.

The competition exchange parameter refers to a quantity of electronic certificates expected to be deducted during current publication of network media information, that is, a parameter based on which exchange between an action of publishing the network media information and electronic certificates is performed; for example, in the Internet advertisement field, the parameter generally refers to a price for publishing an advertisement. In the embodiments, an exchange parameter is short for an electronic certificate exchange parameter. An electronic certificate is an electronic exchange tool, that is, an electronic payment certificate, for example, a digital currency or an electronic card.

Step 302: Receive competition reply messages returned by the more than one publishing party; and determine, according to the competition reply messages, whether corresponding publishing parties participate in competition, competition durations of participating in the competition, and competition exchange parameters.

The received competition reply message includes information indicating whether a publishing, party participates in the competition; and if yes, further includes a determined competition duration and as determined competition exchange parameter.

For example, assuming that n publishing parties reply with effective competition reply messages, where an effective competition reply message refers to that a publishing party participates in as current competition, and the competition reply message includes a competition duration and a competition exchange parameter that are determined by the publishing party, the a publishing parties that participate in the competition determine to competition durations, which are separately C₁, C₂, . . . , Cₙ; and correspondingly, there are n competition exchange parameters, which are separately P₁, P₂, . . . , Pₙ.

In an embodiment, after the receiving competition reply messages returned by the more than one publishing party; and determining, according to the competition reply messages, whether corresponding publishing parties participate in competition, competition durations of participating in the competition, and competition exchange parameters, the method further includes: modifying, according to specified secret bidding competition logic, a competition exchange parameter corresponding to each publishing party. A modification manner may be as follows:

dividing the competition exchange parameter of each publishing party that participates in the competition by a competition duration of the publishing party, to obtain a competition exchange parameter per unit time of the publishing party, that is Pᵢ/Cᵢ, where i is a serial number of the publishing party, Pᵢ is a competition exchange parameter, and Cᵢ is a competition duration.

Modification is performed by using the following formula for each publishing party that participates in the competition:

Wᵢ=min{Cᵢ×Hᵢ, Pᵢ}, where Wᵢ is a competition exchange parameter obtained after modification, where

i is a serial number of the current publishing party, and Hᵢ=max{Qᵢ, Kᵢ}, where a method for determining Qᵢ is: selecting competition exchange parameters per unit time that are less than the competition exchange parameter per unit time of a current publishing party from competition exchange parameters per unit time of all the publishing parties that participate in the competition, and selecting a maximum competition exchange parameter per unit time as Qᵢ from the selected competition exchange parameters per unit time; and a method for determining Kᵢ is: selecting a minimum competition exchange parameter per unit time as Kᵢ from the competition exchange parameters per unit time of all the publishing parties that participate in the competition,

After the foregoing modification, the n competition exchange parameters P₁, P₂, . . . , Pₙ are modified to W₁, W₂, . . . , Wₙ.

In secret bidding competition logic, for Internet advertisements, the competition exchange parameter may be a bid of a publishing party, and the competition exchange parameter obtained after modification may also be referred to as a winner competition exchange parameter.

For example, in a video advertisement display request, a total duration of a target display position is 45 seconds, and a bottom price for 15 seconds is 7 yuan. Competition durations and bids in collected competition reply messages that are returned after competition computation servers of external publishing parties participate in competition computation specifically include:

publishing party A: 15 seconds, and a bid of 7 yuan publishing party B: 30 seconds, and a bid of 18 yuan; and

publishing party C: 15 seconds, and a bid of 8 yuan; publishing party D: 15 seconds, and a bid of 10 yuan.

According to the secret bidding, competition logic, an average hid per second of each publishing party can be obtained by pre-computation as follows:

publishing party A: 7/15 yuan per second, and publishing party B; 9/15 yuan per second; and

publishing party C: 8/15 yuan per second, and publishing party D: 10/15 yuan per second,

Ranking is performed as follows: D>B>C>A; and bids of the publishing parties after modification can be computed, which are also referred to as transaction prices for charging, and are respectively as follows:

transaction price for charging publishing party A=7/15×15=7 yuan;

transaction price for charging publishing party B 8/15×30=16 yuan;

transaction price for charging publishing party C 7/15×15=7 yuan; and

transaction price for charging publishing party D 9/5×15=9 yuan.

By modifying, according to the foregoing secret bidding competition logic, the competition exchange parameters of the publishing parties that participate in the competition, competition enthusiasm of the publishing parties can be improved, and more publishing parties participate in the competition for the target display position, thereby reducing a vacancy rate of the target display position, and further improving usage of a network resource.

Corresponding to the foregoing secret bidding logic, the competition exchange parameters returned by the publishing parties that participate in the competition may also be directly used without modification; and this manner is referred to as opened bidding logic.

Certainly, in addition to the secret bidding logic, other competition logic may also be used to modify the competition exchange parameters of the publishing parties that participate in the competition.

Step 303: Select, according to the competition durations and the competition exchange parameters (which refer to competition exchange parameters obtained after modification herein and hereinafter if the foregoing competition exchange parameters are modified) from the publishing parties that participate in the competition, a group of publishing parties whose competition duration sum is less than or equal to the total duration of the target display position and whose competition exchange parameter sum is a maximum value.

Assuming that the competition exchange parameters in this step are modified, in this step, selection from the publishing parties that participate in the competition needs to be performed according to the n competition durations C₁, C₂, . . . , Cₙ and the n competition exchange parameters W₁, W₂, . . . , Wₙ. In this case, a problem to be solved is essentially converted to how to select some publishing parties from the n publishing parties that participate in the competition, to satisfy the conditions that a competition duration sum of the selected publishing parties is less than or equal to the total duration of the target display position, and a competition exchange parameter sum of the selected publishing parties is a maximum value among values of all combinations. This is a typical knapsack problem. A combination that satisfies the foregoing conditions may be selected by using a traverse and exhaustion approach, and may also be solved by using a dynamic programming approach.

In a preferred embodiment, the publishing party combination that satisfies the foregoing conditions may be solved by means of dynamic programming, and specific solving processing is as follows:

For the n publishing parties a1 to an that participate in the competition, selection for each publishing party can only be 0 or 1 (that is, the publishing party is not selected or is selected); therefore, the problem is converted into searching for a 0/1 integer sequence x1 to xn, where xi=0 or xi=1.

Assuming that x1 to xi is an optimal candidate combination selected from i publishing parties a1 to ai that participate M the competition, where xi=0 or xi=1, x1 to x(i−1) must be an optimal candidate combination selected from publishing parties a1 to a(i−1).

F[i][j] is set as the maximum value of the competition exchange parameter sum that can be obtained when publishing parties in an integer sequence x1 to xi are selected from the publishing parties al to ai that participate in the competition and a competition duration sum of the selected publishing parties does not exceed j, where i≧1 and 0≦j≦the total duration of the target display position.

A decision is made according to whether the i^{th} publishing party that participates in the competition is selected or not; and F[i][j] can be computed by using F[i−1][j], which is shown in the following formula (I):

when (j<Cᵢ), F[i][j]=F[i−1][j], and the i^{th} publishing party is not selected; and when

$$F [ i ] [ j ] = Max \{ \begin{matrix}F [ i - 1 ] [ j ] , \\ F [ i - 1 ] [ j - {C}_{i} ] + {W}_{i} ,\end{matrix}$$

F[i−1][j] represents a maximum value of a competition exchange parameter sum of selected publishing parties, where the maximum value is obtained after some publishing parties are selected from first (i−1) publishing parties that participate in the competition and a competition duration sum of the selected publishing parties is j.

F[i−1][j−Cᵢ]+Wᵢ represents a sum of a maximum value of a competition exchange parameter sum of selected publishing parties and a competition exchange parameter of the i^{th} publishing party, where the maximum value is obtained after some publishing parties are selected from first (i−1) publishing parties that participate in the competition and a competition duration sum of the selected publishing parties is j−Cᵢ. F[i][j] obtained when the i^{th} publishing party is traversed is determined according to whether the i^{th} publishing party that participates in the competition is selected or not, and then a competition duration sum j of selected publishing parties and a maximum value among competition exchange parameter sums of all candidate publishing party combinations can be obtained. In addition, selection conditions of all candidate publishing party combinations a1 to ai are recorded in the computation process. In this way, publishing parties that can be selected to obtain the maximum value of the competition exchange parameter sum can be known.

An example is used below for description:

For example, in a video advertisement display request, a total duration of a target display position is 20 seconds. Competition durations and bids in collected competition reply messages that are returned after competition computation servers of external publishing parties participate in competition computation specifically include:

publishing party A: 5 seconds, and a bid of 5 yuan; publishing party B: 10 seconds, and a bid of 12 yuan; and

publishing party C: 4 seconds, and a bid of 3 yuan: publishing party D: 15 seconds, and a bid of 16 yuan.

An initial value F[0][j] is 0. 1≦i≦4 and 0≦j≦20. Starting from i=0 and j=0, traverse computation is performed according to the foregoing formula (1) on selection conditions of the publishing parties that participate in the competition, and in this way, values of F[i][j] shown in Table 1 can be computed; and selection information of the publishing parties a1 to ai that participate in the competition is recorded during each computation, that is, values of x1 to xi are determined, where a value is 0 if a publishing party is selected; otherwise, the value is 1.

TABLE 1

| | j | | | | | | | | | | | | | | | | | | | | |
|---|---|---|---|---|---|---|---|---|---|---|---|---|---|---|---|---|---|---|---|---|---|
| i | 0 | 1 | 2 | 3 | 4 | 5 | 6 | 7 | 8 | 9 | 10 | 11 | 12 | 13 | 14 | 15 | 16 | 17 | 18 | 19 | 20 |
| 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 1 | 0 | 0 | 0 | 0 | 0 | 5 | 5 | 5 | 5 | 5 | 5 | 5 | 5 | 5 | 5 | 5 | 5 | 5 | 5 | 5 | 5 |
| 2 | 0 | 0 | 0 | 0 | 0 | 5 | 5 | 5 | 5 | 5 | 12 | 12 | 12 | 12 | 12 | 17 | 17 | 17 | 17 | 17 | 17 |
| 3 | 0 | 0 | 0 | 0 | 3 | 5 | 5 | 5 | 5 | 8 | 12 | 12 | 12 | 12 | 15 | 17 | 17 | 17 | 17 | 20 | 20 |
| 4 | 0 | 0 | 0 | 0 | 3 | 5 | 5 | 5 | 5 | 8 | 12 | 12 | 12 | 12 | 15 | 17 | 17 | 17 | 17 | 20 | 21 |

The maximum value of F[i][j] is selected from the foregoing traverse computation results, and corresponding i and j are determined, where as shown in Table 1, the maximum value is 21, and corresponding i and j are respectively 4 and 20; and selected publishing parties corresponding to the maximum value are determined according to the recorded selection information as a selection result, and the selection result is then output. For example, values of x1 to xi herein may be (1, 0, 0, 1), which indicates that publishing party A and publishing party D are selected as selected publishing parties and are processed in subsequent steps, and a maximum value of a competition exchange parameter sum of the selected publishing parties is 21 (F[4][20]).

It is assumed that the total duration of the target display position is 20 in the above example liar ease of description. In practice, a playback duration of network media information may be 60 seconds or any other value; and a duration of network media information for which a bid is made may also be a more standard value such as 5 seconds, 10 seconds, or 15 seconds.

Step 304: Send network media information of the selected publishing parties to the target display position for publishing.

In this step, in a specific method, the network media information of the selected publishing parties may be sent, according to display durations, to the target display position for publishing, where a display duration of network media information of each publishing party is a competition duration in a competition reply message returned by the publishing party.

More specifically, the publication control apparatus according to the embodiment of the present invention may return a list of the network media information of the selected publishing parties to a display terminal, where the list includes content of and a competition duration corresponding to each piece of the network media information; and the display terminal sequentially displays corresponding network media information at a target display position according to the competition duration of each piece of the network media information. For example, according to the foregoing example, publishing party A and publishing party D are selected, and competition durations of publishing party A and publishing party D are respectively 5 seconds and 15 seconds; and in this way, the display terminal sequentially displays, at the target display position, that is, in the pre-roll, network media information of publishing party A for 5 seconds and network media information of publishing party D for 15 seconds.

Further, after the network media information of the selected publishing parties is sent to the target display position for publishing and displaying, the method may further include: charging a selected publishing party according to a competition exchange parameter of the corresponding publishing party. For example, publishing party A and publishing party D are finally selected in the foregoing example; and then, a total charged price is 5+16=21 yuan.

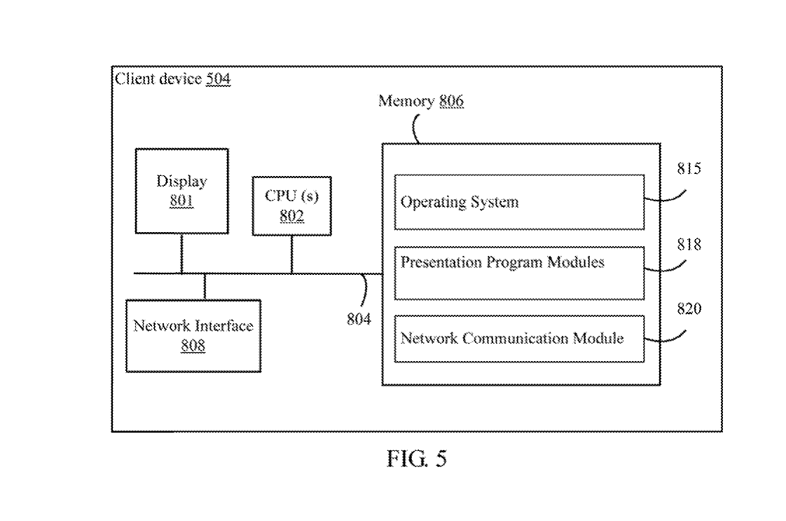

FIG. 5 is a schematic composition diagram of a client device according to an embodiment of the present invention. The client device 504, typically, includes a display 801, one or more processing units (CPUs) 802, one or more network interfaces 808, memory 806, and one or more communication buses 804 for interconnecting these components (sometimes called a chipset).

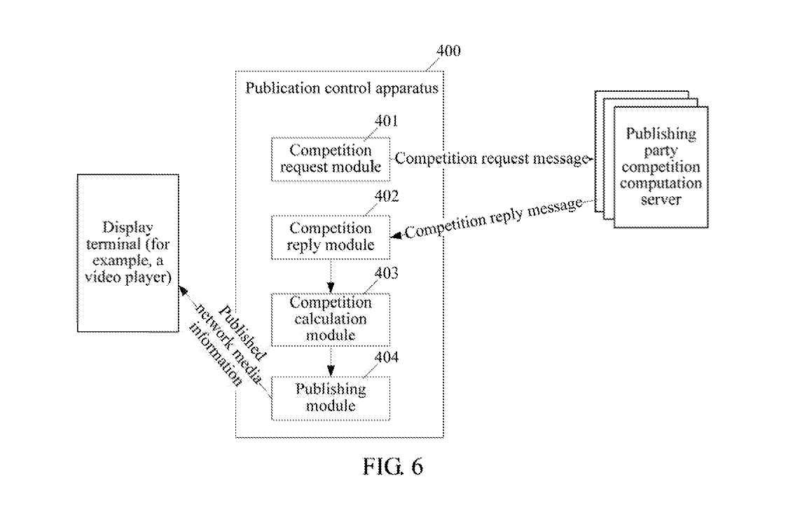

Memory 806 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 806, optionally, includes one or more storage devices remotely located from one or more processing system 815. Memory 806, or alternatively the non-volatile memory within memory 806, includes a non-transitory computer readable storage medium. In some implementations, memory 806, or the non-transitory computer readable storage medium of memory 806, stores data structures, or a subset or superset thereof.
operating system 815 including procedures for handling various basic system services and for performing hardware dependent tasks;
network communication module 818 for connecting client device 504 to other computing devices (e.g., server system and machine servers) connected to one or more networks via one or more network interfaces 808 (wired or wireless).
client device 504 stores presentation program modules described in FIG. 6.

Corresponding to the foregoing method, the present disclosure further discloses an apparatus for controlling publication of network media information. FIG. 6 is a schematic composition diagram of the apparatus for controlling publication of network media information of the present disclosure. Referring to FIG. 6, the publication control apparatus includes:

a competition request module 401, configured to send a competition request message to more than one publishing party, the competition request message including a request duration, and the request duration being less than or equal to a total duration of a target display position;

a competition reply module 402, configured to receive competition reply messages returned by the more than one publishing party; and determine, according to the competition reply messages, whether corresponding publishing parties participate in competition, competition durations of participating in the competition, and competition exchange parameters;

a competition computation module 403, configured to select, according to the competition durations and the competition exchange parameters from the publishing parties that participate in the competition, a group of publishing parties whose competition duration sum is less than or equal to the total duration of the target display position and whose competition exchange parameter sum is a maximum value; and

a publishing module 404, configured to send network media information of the selected publishing parties to the target display position for publishing.

In a preferred embodiment, the publishing module 404 is specifically configured to send, according to display durations, the network media information of the selected publishing parties to the target display position for publishing, where a display duration of network media information of each publishing party is a competition duration in a competition reply message returned by the publishing party.

In a preferred embodiment, the competition request module 401 further includes a request control module, configured to determine a publishing party to which the competition request message is sent and a request duration corresponding to the publishing party, where the request duration is less than or equal to the total duration of the target display position.

In a preferred embodiment, the competition reply module 402 is further configured to modify, according to specified secret bidding competition logic, a competition exchange parameter corresponding to each publishing party, where reference may be made to the description in the foregoing method for a specific modification method,

In the present disclosure, triggering the competition request module to send the competition request message to more than one publishing party may be implemented in multiple manners.

In an embodiment of the present invention, the publication control apparatus may actively trigger the competition request module to send the competition request message to more than one publishing party perform computation to obtain network media information that needs to be displayed at each target display position; and after a display terminal sends a display request, send the network media information that needs to be displayed at each target display position to the display terminal for display.

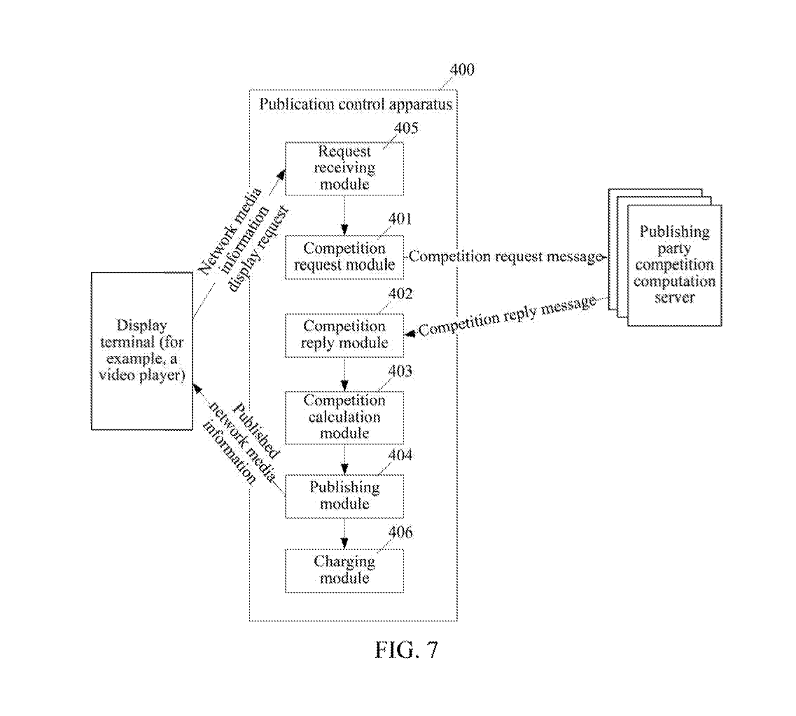

FIG. 7 is another schematic composition diagram of an apparatus for controlling publication of network media information according to an embodiment of the present invention. Referring to FIG. 7, in this embodiment, the display terminal may trigger the publication control apparatus in real time to send the competition request message to more than one publishing party, that is, when a user starts a display terminal having a network media information display position with a specified playback duration, the display terminal sends a network media information display request to the competition request module 401 of the present disclosure, where the request includes information about a target display position, and the information about the target display position may include an ID and a total duration of the target display position, or the information about the target display position may only include an ID of the display position, so that the competition request module of the present disclosure queries a display position database according to the ID of the display position to obtain corresponding total duration.

In this embodiment, the publication control apparatus further includes a request receiving module 405, configured to receive a network media information display request from a network media information display terminal, where the display request includes information about the target display position; forward the display request to the competition request module 401; and trigger the competition request module 401 to send the competition request message to more than one publishing party. In this way, according to the request from the display terminal, real-time competition computation can be implemented, and corresponding network media information can be published; therefore, the publication control apparatus of the present disclosure is also as real-time competition computation system.

For ease of charging, the publication control apparatus of the present disclosure further includes a charging module 406, configured to charge a selected publishing party according to a competition exchange parameter (which is a competition exchange parameter obtained after modification herein if the foregoing competition exchange parameter is modified) of the corresponding publishing party.

In addition, the present disclosure further discloses a system for controlling publication of network media information. As shown in FIG. 6 and FIG. 7, the publication control system includes a front end display apparatus, the apparatus for controlling publication of network media information according to any one of the foregoing embodiments, and a publishing party apparatus (such as a competition computation server).

The display terminal is configured to: send a network media information display request to the publication control apparatus when a target display position is opened, receive network media information published by the publication control apparatus, and display the received network media information at the target display position. If the network media information is network media information of more than one publishing party and includes a corresponding competition duration, the display terminal displays each piece of the network media information at the target display position according to as competition duration of the corresponding network media information.

The publishing party competition computation server is configured to: receive a competition request message from the publication control apparatus; perform computation according to competition computation logic set by the publishing party competition computation server, to determine whether to participate in competition, a competition duration of participating in the competition, and a competition exchange parameter; and return, to the publication control apparatus, a competition reply message that carries information indicating whether to participate in the competition, the competition duration of participating in the competition, and the competition exchange parameter.

The network media information processing technologies of the present disclosure are applicable to many industry fields, for example, applicable to the field of Internet advertisement display processing, where an Internet advertisement may be regarded as network media information.

In addition, the functional modules in the embodiments of the present invention may be integrated into one processing unit, or each of the modules may exist alone physically, or two or more modules are integrated into one unit. The integrated unit may be implemented in the form of hardware, or may be implemented in the form of a software functional unit. The functional modules in the embodiments may be located in one terminal or network node, or may be distributed on multiple terminals or network nodes.

In addition, each embodiment of the present invention may be implemented by a data processing program that is executed by a data processing device such as a computer. Apparently, the data processing program constitutes the present disclosure. In addition, generally a data processing program stored in a storage medium is executed by directly reading the program from the storage medium or by installing or copying the program to a storage device (such as a hard disk and/or memory) of a data processing device. Therefore, such a storage medium also constitutes the present disclosure. In the embodiments, the storage medium is a non-transitory storage medium, and may use any type of recording, for example, a paper storage medium (such as a paper tape), a magnetic storage medium (such as a floppy disk, a hard disk, or as flash memory), an optical storage medium (such as a CD-ROM), or a magneto-optical storage medium such as an MO).

The foregoing descriptions are merely preferred embodiments of the present invention, but are not intended to limit the present disclosure. Any modification, equivalent replacement, or improvement made within the spirit and principle of the present disclosure shall fall within the protection scope of the present disclosure.

What is claimed is:

1. A method for controlling publication of network media information, applied to a client device, the client device comprising one or more processors and a memory for storing a program instruction, the program instruction being executed by the one or more processors to implement the control method, and the method comprising:
sending a competition request message to more than one publishing party, the competition request message comprising a request duration, and the request duration being less than or equal to a total duration of a target display position;
receiving competition reply messages returned by the more than one publishing party; and determining, according to the competition reply messages, whether corresponding publishing parties participate in competition, competition durations of participating in the competition, and competition exchange parameters;
selecting, according to the competition durations and the competition exchange parameters from the publishing parties that participate in the competition, a group of publishing parties whose competition duration sum is less than or equal to the total duration of the target display position and whose competition exchange parameter sum is a maximum value; and
sending network media information of the selected publishing parties to the target display position for publishing.

2. The method according to claim 1, wherein the sending network media information of the selected publishing parties to the target display position for publishing comprises: sending the network media information of the selected publishing parties to the target display position for publishing, wherein a display duration of network media information of each publishing party is a competition duration in a competition reply message returned by the publishing party, and a sequence of sending the network media information of the selected publishing parties to the target display position for publishing is determined by as length of a display duration of each piece of the network media information.

3. The method according to claim 1, before the competition request message is sent, further comprising: determining a publishing party to which the competition request message is sent and a request duration corresponding to the publishing party, wherein the request duration is less than or equal to the total duration of the target display position.

4. The method according to claim 1, after the receiving competition reply messages returned by the more than one publishing party; and determining, according to the competition reply messages, whether corresponding publishing parties participate in competition, competition durations of participating in the competition, and competition exchange parameters, further comprising: modifying, according to specified secret bidding competition logic, a competition exchange parameter corresponding to each publishing party.

5. The method according to claim 4, wherein for each publishing party that participates in the competition, a competition exchange parameter corresponding to the publishing party is modified according to the secret bidding competition logic in the following manner:
dividing the competition exchange parameter of each publishing party that participates in the competition by a competition duration of th publishing party, to obtain a competition exchange parameter per unit time of the publishing party; and
executing, the following modification method for each publishing party that participates in the competition:
a competition exchange parameter obtained after modification Wᵢ=min{Cᵢ×Hᵢ, Pᵢ}, wherein
i is a serial number of the publishing party, Cᵢ is a competition duration of the publishing party, and Pᵢ is a competition exchange parameter of the publishing party; and
Hᵢ=max{Qᵢ, Kᵢ}, wherein
a method for determining, Qᵢ is: selecting competition exchange parameters per unit time that are less than a competition exchange parameter per unit time of a current publishing party from competition exchange parameters per unit time of all the publishing parties that participate in the competition, and selecting a maximum competition exchange parameter per unit time as Qᵢ from the selected competition exchange parameters per unit time; and
a method for determining Kᵢ is: selecting a minimum competition exchange parameter per unit time as Kᵢ from the competition exchange parameters per unit time of all the publishing parties that participate in the competition.

6. The method according to claim 1, wherein the method further comprises: charging a selected publishing party according to a competition exchange parameter of the publishing party.

7. The method according to claim 1, wherein the selecting, from the publishing parties that participate in the competition, a group of publishing parties whose competition duration sum is less than or equal to the total duration of the target display position and whose competition exchange parameter SUM is a maximum value comprises:
setting F[i][j] as the maximum value of the competition exchange parameter sum that can be obtained when publishing parties in an integer sequence are selected from the publishing parties that participate in the competition and a competition duration sum of the selected publishing parties in the integer sequence does not exceed j, wherein i≧1, and 0≦j≦the total duration of the target display position;
starting from i=0 and j=0, performing, according to the competition durations and the competition parameters of the publishing parties that participate in the competition, traverse computation on selection conditions of the publishing parties that participate in the competition by using the following formula (1); and recording selection information of the publishing parties that participate in the competition during each computation, wherein formula (1) is as follows;
when (j<Cᵢ), F[i][j]=F[i−1][j], and the i^{th} publishing party is not selected; and when
$$F [ i ] [ j ] = Max \{ \begin{matrix}F [ i - 1 ] [ j ] , \\ F [ i - 1 ] [ j - {C}_{i} ] + {W}_{i} ,\end{matrix}$$
and
selecting the maximum value of F[i][j] from traverse computation results; and determining, from the recorded selection information, a selected publishing party corresponding to the maximum value as a selection result and outputting the selection result.

8. An apparatus for controlling publication of network media information, comprising;
one or more processors; and
a memory, configured to store multiple program modules;
the multiple program modules being executed by the one or more processors, and the multiple program modules comprising:
a competition request module, configured to send a competition request message to more than one publishing party, the competition request message comprising a request duration, and the request duration being less than or equal to a total duration of a target display position;
a competition reply module, configured to receive competition reply messages returned by the more than one publishing party; and determine, according to the competition reply messages, whether corresponding publishing parties participate in competition, competition durations of participating in the competition, and competition exchange parameters;
a competition computation module, configured to select, according to the competition durations and the competition exchange parameters from the publishing parties that participate in the competition, a group of publishing parties whose competition duration sum is less than or equal to the total duration of the target display position and whose competition exchange parameter sum is a maximum value; and
a publishing module, configured to send network media information of the selected publishing parties to the target display position for publishing.

9. The apparatus according to claim 8, wherein the publishing module is configured to send network media information of the selected publishing parties to the target display position for publishing, wherein a display duration of network media information of each publishing party is a competition duration in a competition reply message returned by the publishing party, and a sequence of sending the network media information of the selected publishing parties to the target display position for publishing is determined by a length of a display duration of each piece of the network media information.

10. The apparatus according to claim 8, wherein the competition request: module further comprises a request control module, configured to determine a publishing party to which the competition request message is sent and a request duration corresponding to the publishing party, wherein the request duration is less than or equal to the total duration of the target display position.

11. The apparatus according to claim 8, wherein the competition reply module is further configured to modify, according to specified secret bidding competition logic, a competition exchange parameter corresponding to each publishing party.

12. The apparatus according to claim 8, wherein the apparatus further comprises a charging module, configured to charge a selected publishing party according to a competition exchange parameter of the corresponding publishing party.

13. The apparatus according to claim 8, wherein the apparatus further comprises a request receiving module, configured to receive a network media information display request from a network media information display terminal, wherein the display request comprises information about the target display position; forward the display request to the competition request module; and trigger the competition request module to send the competition request message to more than one publishing party.

14. A system for controlling publication of network media information, comprising a front end display apparatus and a publishing party apparatus,
the front end apparatus sends a competition request message to more than one publishing party, the competition request message comprising a request duration, and the request duration being less than or equal to a total duration of a target display position; receives competition reply messages returned by the more than one publishing party; and determines, according to the competition reply messages, whether corresponding publishing parties participate in competition, competition durations of participating in the competition, and competition exchange parameters; selects, according to the competition durations and the competition exchange parameters from the publishing parties that participate in the competition, a group of publishing parties whose competition duration sum is less than or equal to the total duration of the target display position and whose competition exchange parameter sum is a maximum value; and sends network media information of the selected publishing parties to the target display position for publishing,
the front end apparatus further sends a network media information display request to the publication control apparatus when a target display position is opened, receives network media information published by the publication control apparatus, and displays the received network media information at the target display position; and
the publishing party apparatus receives a competition request message from the publication control apparatus; performs computation according to competition computation logic set by the publishing party apparatus, to determine whether to participate in competition, a competition duration of participating in the competition, and a competition exchange parameter; and returns, to the publication control apparatus, a competition reply message that carries information indicating whether to participate in the competition, the competition duration of participating in the competition, and the competition exchange parameter.

15. The system according to claim 14, wherein if network media information published by the publication control apparatus is network media information of more than one publishing party and comprises a corresponding competition duration, the display terminal displays each piece of the network media information at the target display position according to a competition duration of the corresponding network media information.

16. The system according to claim 14, wherein the front end apparatus sends network media information of the selected publishing parties to the target display position for publishing, wherein a display duration of network media information of each publishing party is a competition duration in a competition reply message returned by the publishing party, and a sequence of sending the network media information of the selected publishing parties to the target display position for publishing, is determined by a length of a display duration of each piece of the network media information.

17. The system according to claim 14, wherein the front end apparatus further determines a publishing party to which the competition request message is sent and a request duration corresponding to the publishing party, wherein the request duration is less than or equal to the total duration of the target display position.

18. The system according to claim 14, wherein the front end apparatus further modifies, according to specified secret bidding competition logic, a competition exchange parameter corresponding to each publishing party.

19. The system according to claim 14, wherein the front end apparatus further charges a selected publishing party according to a competition exchange parameter of the corresponding publishing party.

20. The system according to claim 14, wherein the front end apparatus further comprises a request receiving module, configured to receive a network media information display request from a network media information display terminal, wherein the display request comprises information about the target display position; forward the display request to the competition request module; and trigger the competition request module to send the competition request message to more than one publishing party.
